(19) United States
(12) Patent Application Publication
(10) Pub. No.: US 2024/0355150 A1
(43) Pub. Date: Oct. 24, 2024

(54) BIOMETRIC IMAGING SYSTEM, BIOMETRIC IMAGING APPARATUS, BIOMETRIC IMAGING METHOD, AND RECORDING MEDIUM

(71) Applicant: NEC Corporation, Minato-ku, Tokyo (JP)

(72) Inventor: Shizuo SAKAMOTO, Tokyo (JP)

(73) Assignee: NEC Corporation, Minato-ku, Tokyo (JP)

(21) Appl. No.: 18/685,001

(22) PCT Filed: Sep. 3, 2021
(86) PCT No.: PCT/JP2021/032491

§ 371 Date: Feb. 20, 2024

(51) Int. Cl. G06V 40/60; G06V 40/10

(52) U.S. Cl. CPC G06V 40/60; G06V 40/10

(57) ABSTRACT

A biometric imaging system includes: an imaging unit that images a living body present in an imaging range; a filling unit that fills the imaging range with liquid; and a guide unit that guides the living body to an arrangement position where the living body is to be placed, by using the liquid. According to such a biometric imaging system, it is possible to guide the living body to an appropriate position to capture an image.

### TECHNICAL FIELD

This disclosure relates to technical fields of a biometric imaging systems, a biometric imaging apparatus, a biometric imaging method, and a recording medium.

### BACKGROUND ART

A known system of this type guides a position of a living body when an image of the living body is captured. For example, Patent literature 1 discloses a technique/technology of displaying a three-dimensional image that guides a finger when a fingerprint image is captured. Patent literature 2 discloses a technique/technology of turning on a LED in order to inform a user of timing and speed at which a fingertip passes through when an image of the fingerprint is captured. Patent literature 3 discloses a technique/technology of guiding a finger to be positioned by using a positioning projector, and of turning on a display/indicator to indicate the fact that the finger is positioned at a predetermined positioned.

### CITATION LIST

### Patent Literature

Patent Literature 1: JPH05-108808A
Patent Literature 2: JP2006-139592A
Patent Literature 3: JP2006-215822A

### SUMMARY

### Technical Problem

This disclosure aims to improve the related techniques/technologies described above.

### Solution to Problem

A biometric imaging system according to an example aspect of this disclosure includes: an imaging unit that images a living body present in an imaging range: a filling unit that fills the imaging range with liquid: and a guide unit that guides the living body to an arrangement position where the living body is to be placed, by using the liquid.

A biometric imaging apparatus according to an example aspect of this disclosure includes: an imaging unit that images a living body present in an imaging range: a filling unit that fills the imaging range with liquid: and a guide unit that guides the living body to an arrangement position where the living body is to be placed, by using the liquid.

A biometric imaging method according to an example aspect of this disclosure is a biometric imaging method executed by at least one computer, the biometric imaging method including: filling an imaging range of an imaging unit with liquid: guiding a living body to an arrangement position where the living body is to be placed, by using the liquid: and imaging the guided living body.

A recording medium according to an example aspect of this disclosure is a recording medium on which a computer program that allows at least one computer to execute the biometric imaging method is recorded, the biometric imaging method including: filling an imaging range of an imaging unit with liquid: guiding a living body to an arrangement position where the living body is to be placed, by using the liquid: and imaging the guided living body.

### BRIEF DESCRIPTION OF DRAWINGS

FIG. 1 is a block diagram illustrating a hardware configuration of a biometric imaging system according to a first example embodiment.

FIG. 2 is a block diagram illustrating a functional configuration of the biometric imaging system according to the first example embodiment.

FIG. 3 is a flowchart illustrating a flow of operation of the biometric imaging system according to the first example embodiment.

FIG. 4 is a side view illustrating a configuration and operation of a biometric imaging system according to a second example embodiment.

FIG. 5A and FIG. 5B are top views illustrating exemplary marks of a container in the biometric imaging system according to the second example embodiment.

FIG. 6A and FIG. 6B are plan views illustrating display examples by the biometric imaging system according to the second example embodiment.

FIG. 7A and FIG. 7B are side views illustrating a configuration and operation of a biometric imaging system according to a third example embodiment.

FIG. 8 is a side view illustrating a configuration and operation of a biometric imaging system according to a fourth example embodiment.

FIG. 9 is a side view illustrating a configuration and operation of a biometric imaging system according to a fifth example embodiment.

FIG. 10 is a side view illustrating a configuration and operation of a biometric imaging system according to a sixth example embodiment.

FIG. 11 is a side view illustrating a configuration and operation of a biometric imaging system according to a seventh example embodiment.

FIG. 12 is a side view illustrating a configuration and operation of a biometric imaging system according to an eighth example embodiment.

FIG. 13 is a side view illustrating a configuration and operation of a biometric imaging system according to a ninth example embodiment.

FIG. 14 is a block diagram illustrating a functional configuration of a biometric imaging system according to a tenth example embodiment.

FIG. 15 is a side view illustrating a configuration and operation of a biometric imaging system according to an eleventh example embodiment.

FIG. 16 is a cross sectional view illustrating the configuration and operation of the biometric imaging system according to the eleventh example embodiment.

FIG. 17 is a side view illustrating a configuration and operation of a biometric imaging system according to a twelfth example embodiment.

### DESCRIPTION OF EXAMPLE EMBODIMENTS

Hereinafter, a biometric imaging system, a biometric imaging apparatus, a biometric imaging method, and a recording medium according to example embodiments will be described while reference to the drawings.

### First Example Embodiment

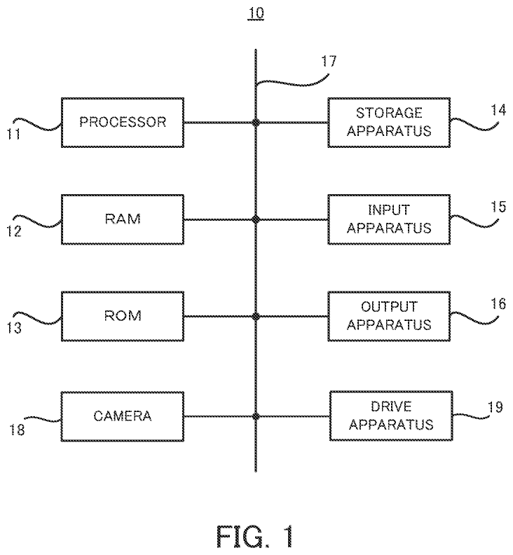

A biometric imaging system according to a first example embodiment will be described with reference to FIG. 1 to FIG. 3.

### (Hardware Configuration)

First, with reference to FIG. 1, a hardware configuration of the biometric imaging system according to the first example embodiment will be described. FIG. 1 is a block diagram illustrating the hardware configuration of the biometric imaging system according to the first example embodiment.

As illustrated in FIG. 1, a biometric imaging system 10 according to the first example embodiment includes a processor 11, a RAM (Random Access Memory) 12, a ROM (Read Only Memory) 13, and a storage apparatus 14. The biometric imaging system 10 may further include an input apparatus 15 and an output apparatus 16. The biometric imaging system 10 may also include a camera 18 and a drive apparatus 19. The processor 11, the RAM 12, the ROM13, the storage apparatus 14, the input apparatus 15, the output apparatus 16, the cameras 18, and the drive apparatus 19 are connected through a data bus 17.

The processor 11 reads a computer program. For example, the processor 11 is configured to read a computer program stored by at least one of the RAM 12, the ROM13, and the storage apparatus 14. Alternatively, the processor 11 may read a computer program stored in a computer-readable recording medium by using a not-illustrated recording medium reading apparatus. The processor 11 may acquire (i.e., read) a computer program from a not-illustrated apparatus disposed outside the biometric imaging system 10, through a network interface. The processor 11 controls the RAM 12, the storage apparatus 14, the input apparatus 15, and the output apparatus 16 by executing the read computer program. Especially in this example embodiment, when the processor 11 executes the read computer program, a functional block for guiding a living body to be positioned to capture an image is realized or implemented in the processor 11.

The processor 11 may be configured, for example, as a CPU (Central Processing Unit), a GPU (Graphics Processing Unit), a FPGA (field-programmable gate array), a DSP (Demand-Side Platform), or an ASIC (Application Specific Integrated Circuit). The processor 11 may include one of these, or may use a plurality of them in parallel.

The RAM 12 temporarily stores the computer program to be executed by the processor 11. The RAM 12 temporarily stores the data that are temporarily used by the processor 11 when the processor 11 executes the computer program. The RAM 12 may be, for example, a D-RAM (Dynamic RAM).

The ROM 13 stores the computer program to be executed by the processor 11. The ROM 13 may otherwise store fixed data. The ROM 13 may be, for example, a P-ROM (Programmable ROM).

The storage apparatus 14 stores the data that are stored for a long term by the biometric imaging system 10. The storage apparatus 14 may operate as a temporary storage apparatus of the processor 11. The storage apparatus 14 may include, for example, at least one of a hard disk apparatus, a magneto-optical disk apparatus, a SSD (Solid State Drive), and a disk array apparatus.

The input apparatus 15 is an apparatus that receives an input instruction from a user of the biometric imaging system 10. The input apparatus 15 may include, for example, at least one of a keyboard, a mouse, and a touch panel. The input apparatus 15 may be configured as a portable terminal such as a smartphone and a tablet.

The output apparatus 16 is an apparatus that outputs information about the biometric imaging system 10 to the outside. For example, the output apparatus 16 may be a display apparatus (e.g., a display) that is configured to display the information about the biometric imaging system 10. The output apparatus 16 may be a speaker or the like that is configured to audio-output the information about the biometric imaging system 10. The output apparatus 16 may be configured as a portable terminal such as a smartphone and a tablet.

The camera 18 is a camera that is configured an image of a living body (e.g., an image of a fingerprint (epidermis, a dermis layer), a palm print, a vein, etc.). The living body here is not limited to a human being, but may include an animal such as a dog, a snake, or the like. The camera 18 may be a camera that captures a still image or a camera that captures a video. The camera 18 may be configured as a visible light camera or as a near infrared camera. The camera 18 may also be configured as an optical scanner.

The drive apparatus 19 is an apparatus that drives each of the components of the biometric imaging system 10. The operation of the drive apparatus 19 may be controlled, for example, by the processor 11. The drive apparatus 19 may include an actuator or the like, for example. In particular, the drive apparatus 19 according to this example embodiment may have a function of filling an area with liquid. In this instance, the drive apparatus 19 may include a housing, a cover, a container, or the like that forms the area to be filled with the liquid. Furthermore, the drive apparatus 19 according to this example embodiment may be configured to drive an apparatus (e.g., a light source, an air blower, etc.) for performing a guide operation using the liquid (described in detail later) and an operation associated therewith.

FIG. 1 illustrates an example of the biometric imaging system 10 including a plurality of apparatuses, but all or a part of the functions may be realized by a single apparatus (or biometric imaging apparatus). The biometric imaging apparatus may include only the processor 11, the RAM 12, and the ROM13 described above, for example, and other components (i.e., the storage apparatus 14, the input apparatus 15, the output apparatus 16, the camera 18, and the drive apparatus 19) may be provided for an external apparatus connected to the biometric imaging apparatus, for example. In addition, the biometric imaging apparatus may realize a part of an arithmetic function by using an external apparatus (e.g., an external server or cloud, etc.).

### (Functional Configuration)

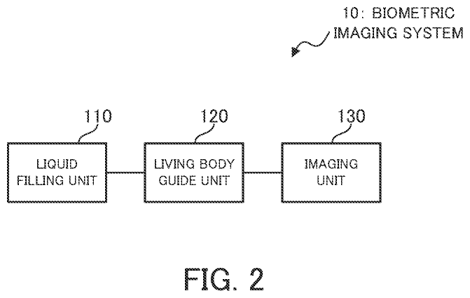

Next, with reference to FIG. 2, a functional configuration of the biometric imaging system 10 according to the first example embodiment will be described. FIG. 2 is a block diagram illustrating the functional configuration of the biometric imaging system according to the first example embodiment.

In FIG. 2, the biometric imaging system 10 according to the first example embodiment is configured as a system that captures an image of a living body. The biometric imaging system 10 may be configured as a system that captures an image used in biometric authentication, for example. The biometric imaging system 10 includes, as components for realizing the functions thereof, a liquid filling unit 110, a living body guide unit 120, and an imaging unit 130.

The liquid filling unit 110 includes, for example, the drive apparatus 19 described above (see FIG. 1), and is configured to fill an imaging range of the imaging unit 130 with liquid. The liquid filling unit 110 may fill the imaging range of the imaging unit 130 with the liquid so as to cover the entire imaging range, or so as to cover only a part of the imaging range. The liquid for filling by the liquid filling unit 110 is liquid that has no problem if it is in contact with the living body; such as water and alcohol, for example. A liquid filling method by the liquid filling unit 110 will be specifically described in another example embodiment described later.

The living body guide unit 120 includes, for example, the drive apparatus 19 (see FIG. 1), and is configured to guide the living body (i.e., an imaging target) to an arrangement position where it is to be placed, by using the liquid for filling by the liquid filling unit 110. Specifically, the living body guide unit 120 is configured to guide the living body to a position suitable for imaging by the imaging unit 130. A guidance method by the living body guide unit 120 will be specifically described in another example embodiment described later.

The imaging unit 130 includes, for example, the camera 18 (see FIG. 1), and is configured to image the living body guided by the living body guide unit 120. The imaging unit 130 has a fixed imaging range, for example, and is configured to image the living body guided into the imaging range by the living body guide unit 120. The imaging unit 130 may be configured as, for example, a non-contact fingerprint scanner, a palmprint scanner, or a vein scanner. The following describes an example in which the imaging unit 130 is configured as a fingerprint scanner (another example embodiment described below also describes an example in which the imaging unit 130 is configured as the fingerprint scanner, but the configuration of the imaging unit 130 is not limited to the fingerprint scanner).

### (Flow of Operation)

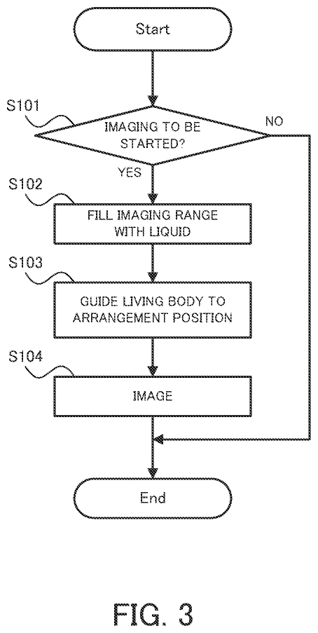

Next, with reference to FIG. 3, a flow of operation of the biometric imaging system 10 according to the first example embodiment will be described. FIG. 3 is a flowchart illustrating the flow of the operation of the biometric imaging system according to the first example embodiment.

As illustrated in FIG. 3, in operation of the biometric imaging system 10 according to the first example embodiment, first, it is determined whether or not to start the imaging of the living body (step S101). Whether or not to start the imaging may be determined, for example, in response to an operation by the user. For example, in a case where the user presses a button to start the imaging, it may be determined that the imaging is to be started. Alternatively, the presence of the living body that is an imaging target may be detected to determine whether or not to start the imaging. For example, in a case where the approach of the user is detected by a sensor or the like provided in the apparatus, it may be determined that the imaging is to be started. When it is determined that the imaging is not to be started (step S101: NO), the subsequent processing is omitted, and a series of operation steps is ended.

On the other hand, when it is determined that imaging is to be started (step S102: YES), the liquid filling unit 110 fills the imaging range of the imaging unit 130 with the liquid (step S102). The liquid filling unit 110 may start the filling with the liquid before the imaging is determined to be started. For example, in a case where the imaging is performed at a relatively high frequency, the filling with the liquid may be performed in advance. Alternatively, preliminary filling with the liquid may be performed (e.g., pre-filling the imaging range with a half amount of the liquid) for early completion of the filling with the liquid.

Subsequently, the living body guide unit 120 guides the living body to the arrangement position, by using the liquid for filling by the liquid filling unit 110 (step S103). Thereafter, the imaging unit 130 images the living body guided by the living body guide 120 (step S104). The imaging unit 130 may image the same living body a plurality of times.

### (Technical Effect)

Next, a technical effect obtained by the biometric imaging system 10 according to the first example embodiment will be described.

As described in FIG. 1 to FIG. 3, in the biometric imaging system 10 according to the first example embodiment, the imaging range of the imaging unit 130 is filled with the liquid, and the living body is guided to the arrangement position by using the liquid. In this way, the living body that is an imaging target is guided to a position suitable for the imaging, and it is possible to capture the image of the living body. Such a technical effect is remarkably exhibited, for example, in a case where the imaging unit 130 has a narrow range to capture an appropriate image (e.g., a narrow focusing range and viewing angle), or the like. In addition, the technical effect is also remarkably exhibited in a case where the arrangement position of the living body is difficult to be transmitted (e.g., in a case where it is required to place the living body in a space of a predetermined range in order to perform the imaging by a non-contact type scanner), or the like.

### Second Example Embodiment

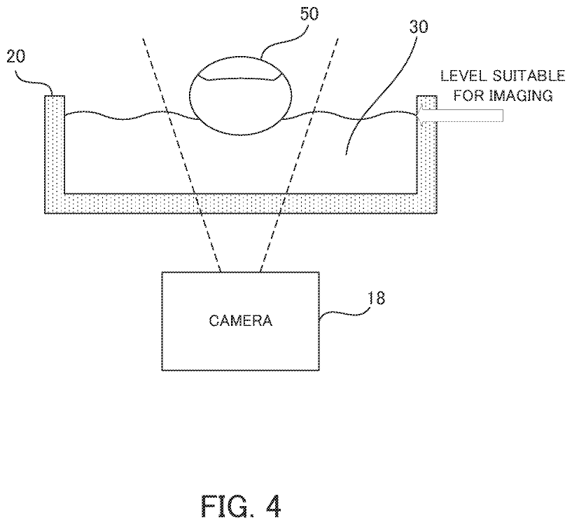

The biometric imaging system 10 according to a second example embodiment will be described with reference to FIG. 4 to FIG. 6B. The second example embodiment is partially different from the first example embodiment only in the configuration and operation, and may be the same as the first example embodiment in the other parts. For this reason, a part that is different from the first example embodiment described above will be described in detail below; and a description of other overlapping parts will be omitted as appropriate.

### (Configuration and Operation)

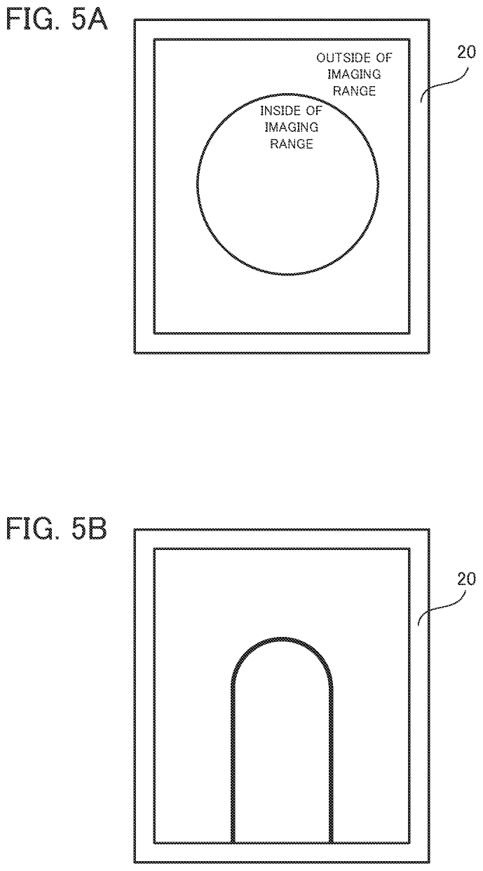

First, with reference to FIG. 4 to FIG. 5B, a configuration and operation of the biometric imaging system 10 according to the second example embodiment will be described. FIG. 4 is a side view illustrating the configuration and operation of the biometric imaging system according to a second example embodiment. FIG. 5A and FIG. 5B are top views illustrating exemplary marks of a container in the biometric imaging system according to the second example embodiment.

As illustrated in FIG. 4, in the biometric imaging system 10 concerning the second example embodiment, the liquid filling unit 110 (see FIG. 2) includes a container 20 that stores the liquid 30. The container 20 is made of, for example, transparent resin, glass, or the like, and the camera 18 disposed below the container 20 is configured to capture an image through the container 20 and the liquid 30. Furthermore, the container 20 may have a function of keeping constant temperature of the liquid 30 for filling.

The living body guide unit 120 is configured to guide the living body to the arrangement position by the amount of the liquid 30 stored in the container 20. Specifically, the living body guide unit 120 determines the amount of the liquid 30 to be stored in the container 20 (in other words, level of a liquid surface), and guides the living body to the arrangement position by the liquid surface. For example, in a case where an image of a fingerprint is captured, the level that a finger 50 touches the liquid surface as illustrated in FIG. 4 is a position where an appropriate image can be captured. The amount of the liquid 30 may be set in accordance with the imaging range and installation position of the camera 18, camera parameters, or the like. Alternatively, the camera parameters may be adjusted in accordance with the amount of liquid 30.

As illustrated in FIG. 5A and FIG. 5B, the container 20 may include a mark for guiding the finger 50 to a lateral (horizontal) position. Specifically, as illustrated in FIG. 5A, a frame line may be provided to indicate an inside of the imaging range and an outside of the imaging range at a bottom of the container 20. Alternatively, as illustrated in FIG. 5B, a frame line may be provided to indicate a contour of the finger. These marks are provided at positions where the finger is in the imaging range of the camera 18 in a case where the finger 50 is placed within the frame line. Furthermore, the mark itself is arranged so as not to interfere with the imaging.

### (Display Example in Guiding)

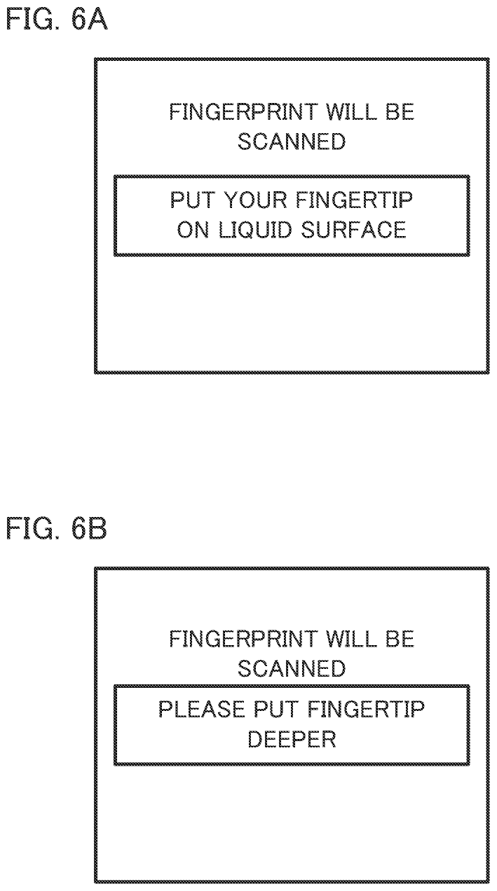

Next, with reference to FIG. 6A and FIG. 6B, a description will be given to display examples when the guiding is performed by the biometric imaging system 10 according to the second example embodiment. FIG. 6A and FIG. 6B are plan views illustrating the display examples by the biometric imaging system according to the second example embodiment.

As illustrated in FIG. 6A and FIG. 6B, in the biometric imaging system 10 according to the second example embodiment, display may be performed to encourage the user to put the finger 50 in the liquid 30. Specifically, a message “Please put your fingertip on the liquid surface” may be displayed as illustrated in FIG. 6A. Furthermore, after the finger 50 is actually placed, a message may be further displayed depending on the arrangement position. For example, when the level of the finger 50 is too high (the finger 50 is put on the liquid surface in a shallower manner than expected), a message “Please put the finger a little deeper” may be displayed as illustrated in FIG. 6B. In addition, when the level of the finger 50 is too low (when the finger 50 is put on the liquid surface deeper than expected), a message “Please put the finger a little more shallowly” may be displayed. In addition, when the level of the finger 50 is appropriate, a message “Please keep the finger at that level” may be displayed. Such display may be performed, for example, by a display or the like provided for the output apparatus 16.

### (Technical Effect)

Next, a technical effect obtained by the biometric imaging system 10 according to the second example embodiment will be described.

As described in FIG. 4 to FIG. 6, in the biometric imaging system 10 according to the second example embodiment, the living body is guided to the arrangement position by storing the liquid 30 in the container 20. In this way, it is possible to properly image the living body while avoiding a contact between the living body and various apparatuses such as the camera 18.

### Third Example Embodiment

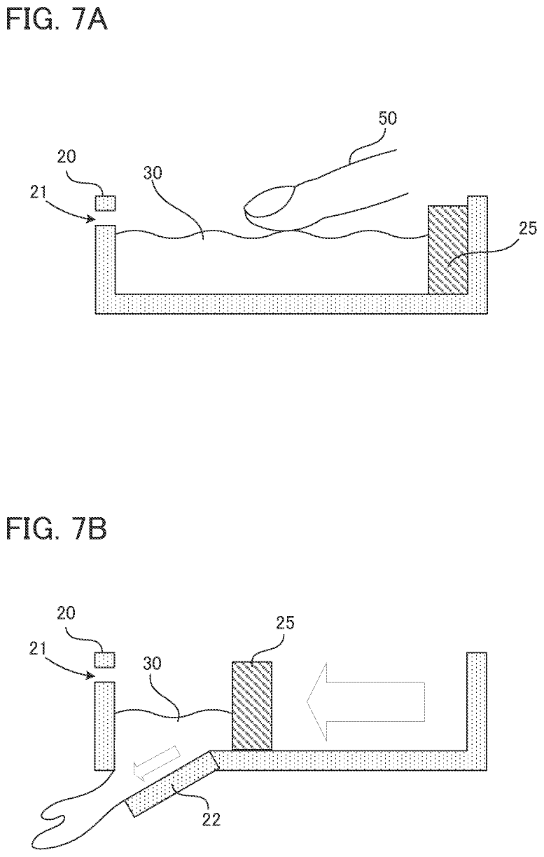

The biometric imaging system 10 according to a third example embodiment will be described with reference to FIG. 7A and FIG. 7B. The third example embodiment is partially different from the first and second example embodiments only in the configuration and operation, and may be the same as each of the example embodiments described above in the other parts. For this reason, a part that is different from each of the example embodiments described above will be described in detail below; and a description of other overlapping parts will be omitted as appropriate.

### (Configuration and Operation)

First, with reference to FIG. 7A and FIG. 7B, a configuration and operation of the biometric imaging system 10 according to the third example embodiment will be described. FIG. 7A and FIG. 7B are side views illustrating the configuration and operation of the biometric imaging system according to the third example embodiment. In FIG. 7A and FIG. 7B, the same components as those illustrated in FIG. 4 carry the same reference numerals.

The biometric imaging system 10 according to the third example embodiment is configured to discharge the liquid 30 stored in the container 20 after the living body is guided to the arrangement position. The liquid 30 may be discharged at the timing when the guiding is ended (e.g., at the timing when the finger 50 is placed in an appropriate position). Alternatively, the liquid 30 may be discharged at the timing when the capture of the image is ended.

As illustrated in FIG. 7A and FIG. 7B, the biometric imaging system 10 according to the third example embodiment includes a discharge drive unit 25 for discharging the liquid 30 stored in the container 20. Specifically, the discharge drive unit 25 is movably configured in the container 20, and this moving makes it possible to push out the liquid 30 stored in the container 20. In the following, a description will be given to a driving example of the discharge drive unit 25.

As illustrated in FIG. 7A, when the liquid 30 is to be stored in the container 20, the discharge drive unit 25 is disposed on an edge of the container 20. At this time, the discharge drive unit 25 may be disposed at an edge opposite to an injection port 21 into which the liquid 30 is poured so as not to impede the storage of the liquid 30 in the container 20.

As illustrated in FIG. 7 B, when the liquid 30 is discharged from the container 20, a discharge port 22 located at the bottom of the container 20 is opened. Then, the discharge drive unit 25 moves to the discharge port 22 side inside the container 20. Such an operation causes the liquid 30 stored in the container 20 to be discharged from the discharge port 22.

The above-described example is merely an example, and the discharge of the liquid 30 may be realized by another configuration.

### (Technical Effect)

Next, a technical effect obtained by the biometric imaging system 10 according to the third example embodiment will be described.

As described in FIG. 7A and FIG. 7B, in the biometric imaging system 10 according to the third example embodiment, the liquid 30 stored in the container 20 is discharged after the living body is guided to the arrangement position. In this way, the container 20 may be kept clean. Furthermore, even when a plurality of users use the same container 20, the liquid 30 in the container 20 is replaced at each time of capturing an image, and it is thus possible to perform the guiding in a clean condition.

### Fourth Example Embodiment

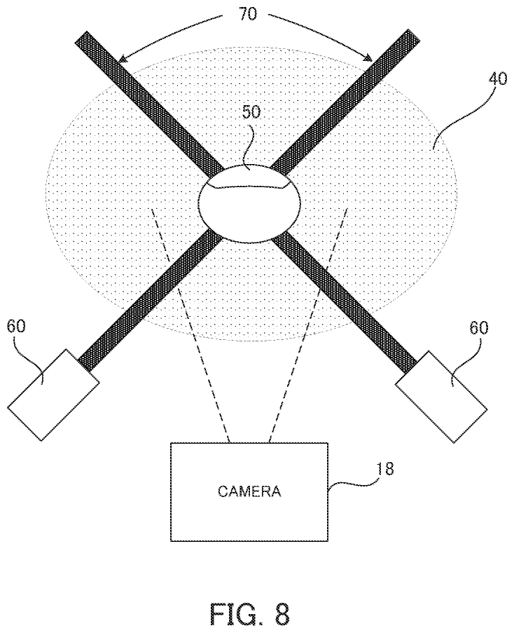

The biometric imaging system 10 according to a fourth example embodiment will be described with reference to FIG. 8. The fourth example embodiment is partially different from the first example embodiment only in the configuration and operation, and may be the same as each of the example embodiments described above in the other parts. For this reason, a part that is different from each of the example embodiments described above will be described in detail below, and a description of other overlapping parts will be omitted as appropriate.

### (Configuration and Operation)

First, with reference to FIG. 8, a configuration and operation of the biometric imaging system 10 according to the fourth example embodiment will be described. FIG. 8 is a side view illustrating the configuration and operation of the biometric imaging system according to the fourth example embodiment. In FIG. 8, the same components as those illustrated in FIG. 4 carry the same reference numerals.

As illustrated in FIG. 8, in the biometric imaging system 10 according to the fourth example embodiment, the liquid filling unit 110 (see FIG. 2) is configured to fill an imaging range of the camera 18 with mist 40 (i.e., mist-like liquid). Furthermore, the living body guide unit 120 (see FIG. 2) includes a light source 60. The light source 60 applies guide light 70 to the mist 40, thereby to guide the living body to the arrangement position.

For example, two light sources 60 are provided, and the guide light 70 is applied from each of the two light sources 60 to an area filled with the mist 40. Then, these two rays of the guide light 70 are arranged to cross at the arrangement position where the living body is to be placed. Therefore, in a case where the image of the fingerprint is captured, it is sufficient to place the finger 50 in a part where the two rays of the guide lights 70 cross.

The above-described arrangement configuration of the light sources 60 is an example, and the living body may be guided to an arrangement position by using a single light source 60, for example. Alternatively, more than two light sources 60 may be used to guide the living body to the arrangement position.

### (Technical Effect)

Next, a technical effect obtained by the biometric imaging system 10 according to the fourth example embodiment will be described.

As described in FIG. 8, in the biometric imaging system 10 according to the fourth example embodiment, the living body is guided to the arrangement position by applying the guide beam 70 to the mist 40. In this way, it is possible to properly capture the image of the living body while avoiding the contact between the living body and various apparatuses such as the camera 18.

### Fifth Example Embodiment

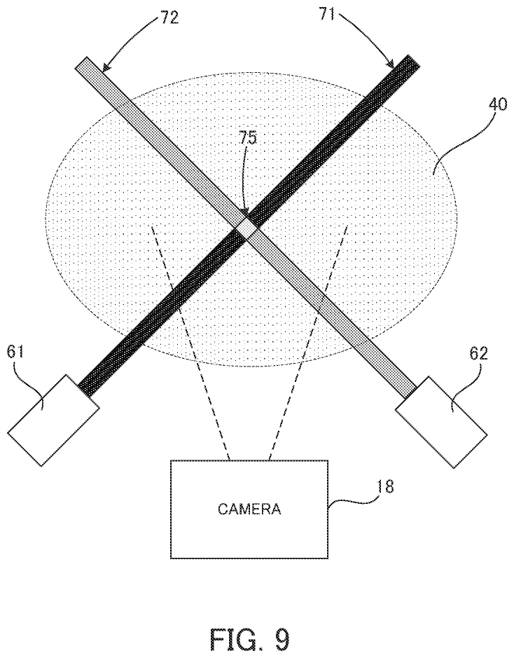

The biometric imaging system 10 according to a fifth example embodiment will be described with reference to FIG. 9. The fifth example embodiment is partially different from the fourth example embodiment only in the configuration and operation, and may be the same as each of the example embodiments described above in the other parts. For this reason, a part that is different from each of the example embodiments described above will be described in detail below, and a description of other overlapping parts will be omitted as appropriate.

### (Configuration and Operation)

First, with reference to FIG. 9, a configuration and operation of the biometric imaging system 10 according to the fifth example embodiment will be described. FIG. 9 is a side view illustrating the configuration and operation of the biometric imaging system according to the fifth example embodiment. In FIG. 9, the same components as those illustrated in FIG. 8 carry the same reference numerals.

As illustrated in FIG. 9, the biometric imaging system 10 according to the fifth example embodiment is configured such that a first light source 61 applies first guide light 71 and a second light source 62 applies second guide light 72. The first guide light 71 is visible light of a first wavelength. The second guide light 72 is visible light of a second wavelength that is different from the first wavelength. That is, the first guide light 71 and the second guide light 2 are guide light with different colors from each other.

The first guide light 71 and the second guide light 72 are arranged to cross at the arrangement position where the living body is to be placed, as in the fourth example embodiment described already: Then, at an intersection 75 where the first guide light 71 crosses the second guide light 72, the color changes (i.e., the color of each of the first guide light 71 and the second guide light 72 changes) because the first guide light 71 and the second guide light 72 have different wavelengths.

### (Technical Effect)

Next, a technical effect obtained by the biometric imaging system 10 according to the fifth example embodiment will be described.

As described in FIG. 9, in the biometric imaging system 10 according to the fifth example embodiment, the first guide light 71 and the second guide light 72 of different wavelengths are applied, by which the color changes at the intersection where they cross. In this way, it is possible to easily allow the user to understand the arrangement position where the living body is to be placed.

### Sixth Example Embodiment

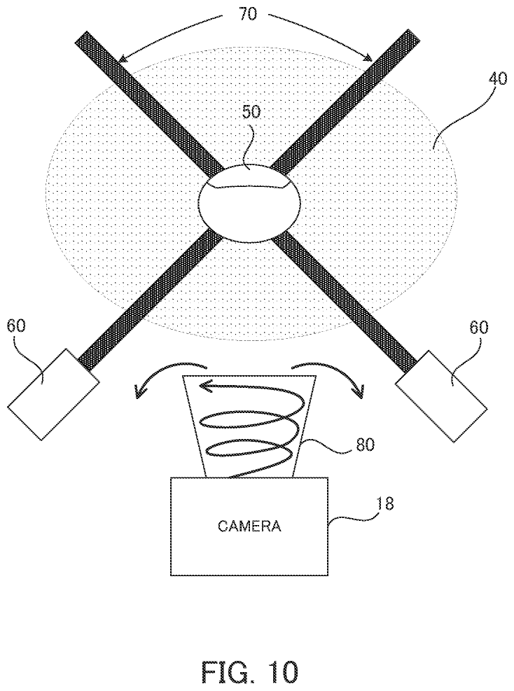

The biometric imaging system 10 according to a sixth example embodiment will be described with reference to FIG. 10. The sixth example embodiment is partially different from the fourth and fifth example embodiments only in the configuration and operation, and may be the same as each of the example embodiments described above in the other parts. For this reason, a part that is different from each of the example embodiments described above will be described in detail below, and a description of other overlapping parts will be omitted as appropriate.

### (Configuration and Operation)

First, with reference to FIG. 10, a configuration and operation of the biometric imaging system 10 according to the sixth example embodiment will be described. FIG. 10 is a side view illustrating the configuration and operation of the biometric imaging system according to the sixth example embodiment. In FIG. 10, the same components as those illustrated in FIG. 8 carry the same reference numerals.

As illustrated in FIG. 10, the biometric imaging system 10 according to the sixth example embodiment further includes a blower cylinder 80, in addition to the configuration in the fourth example embodiment (see FIG. 8). The blower cylinder 80 is disposed between the camera 18 and an area to be filled with the mist 40. The blower cylinder 80 may be provided in contact with the camera 18, for example. The blower cylinder is configured to perform air blowing such that the mist 40 does not adhere to the camera 18. For example, the blower cylinder 80 includes an air blower in the inside or outside thereof.

In the inside of the blower cylinder 80, the air blowing is performed from a lower side toward an upper side (i.e., from the camera 18 side toward the mist 40 side). Then, the blower cylinder 80 is configured to increase its diameter toward the upper side. By making the blower cylinder 80 in such a shape, a vortex flow is generated therein. A flow of air from the blower cylinder 80 may be configured to flow toward the lower side (i.e., in a direction that is different from that of the mist 40), in order not to diffuse the mist 40.

### (Technical Effect)

Next, a technical effect obtained by the biometric imaging system 10 according to the sixth example embodiment will be described.

As described in FIG. 10, in the biometric imaging system 10 according to the sixth example embodiment, the air blowing is performed from the cameras 18 toward the mist 40. In this way, it is possible to prevent that the mist 40 adheres to the camera 18. Therefore, it is possible to prevent that the image of the living body cannot be properly captured due to the adhesion of the mist 40 to the camera 18.

### Seventh Example Embodiment

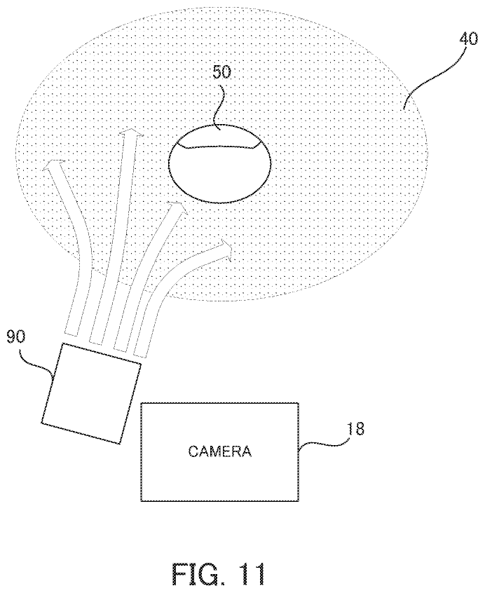

The biometric imaging system 10 according to a seventh example embodiment will be described with reference to FIG. 11. The seventh example embodiment is partially different from the fourth to sixth example embodiments only in the configuration and operation, and may be the same as each of the example embodiments described above in the other parts. For this reason, a part that is different from each of the example embodiments described above will be described in detail below; and a description of other overlapping parts will be omitted as appropriate.

### (Configuration and Operation)

First, with reference to FIG. 11, a configuration and operation of the biometric imaging system 10 according to the seventh example embodiment will be described. FIG. 11 is a side view illustrating the configuration and operation of the biometric imaging system according to the seventh example embodiment. In FIG. 11, the same components as those illustrated in FIG. 8 carry the same reference numerals. Furthermore, in FIG. 11, for convenience of description, illustration is omitted for a component that is less related to this example embodiment out of the components illustrated in FIG. 8.

As illustrated in FIG. 11, the biometric imaging system 10 according to the seventh example embodiment further includes a dry air blower 90, in addition to the configuration in the fourth example embodiment (see FIG. 8). The dry air blower 90 is configured to blow warm air to the area filled with the mist 40. The dry air blower 90 may be common to or different from the blower provided for the blower cylinder 70 described in the sixth example embodiment.

The dry air blower 90 guides the living body to the arrangement position, and then blows the warm air to dry (or blow off) the mist 40. The dry air blower 90 may blow the warm air at the timing when the guiding is ended (e.g., at the timing when the finger 50 is placed at the appropriate position). Alternatively, the dry air blower 90 may blow the warm air at the timing when the capture of the image is ended. The dry air blower 90 may be configured to blow the warm air for a predetermined time and then automatically stop the warm air, for example.

### (Technical Effect)

Next, a technical effect obtained by the biometric imaging system 10 according to the seventh example embodiment will be described.

As described in FIG. 11, in the biometric imaging system 10 according to the seventh example embodiment, the living body is guided to the arrangement position, and then, the warm air is blown to the mist 40. In this way, it is possible to remove the mist 40 used in guiding the living body, from the area filled with the mist 40. It is also possible to remove the mist 40 that adheres to the living body.

### Eighth Example Embodiment

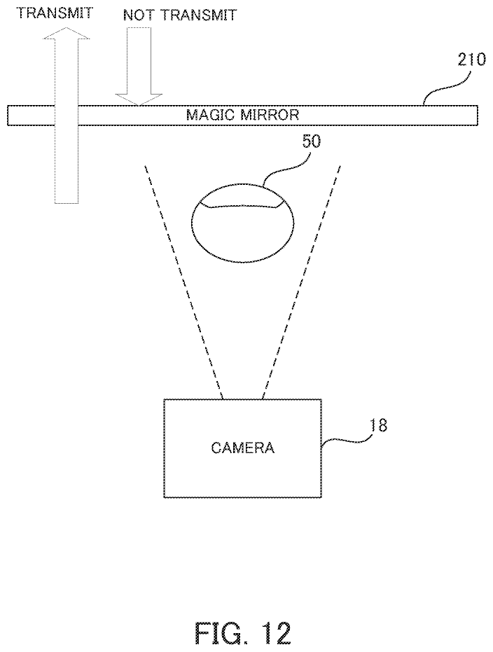

The biometric imaging system 10 according to an eighth example embodiment will be described with reference to FIG. 12. The eighth example embodiment is partially different from the first to seventh example embodiments only in the configuration and operation, and may be the same as each of the example embodiments described above only in the other parts. For this reason, a part that is different from each of the example embodiments described above will be described in detail below; and a description of other overlapping parts will be omitted as appropriate.

### (Configuration and Operation)

First, with reference to FIG. 12, a configuration and operation of the biometric imaging system 10 according to the eighth example embodiment will be described. FIG. 12 is a side view illustrating the configuration and operation of the biometric imaging system according to the eighth example embodiment. In FIG. 12, the same components as those illustrated in FIG. 4 and FIG. 8 carry the same reference numerals. Furthermore, in FIG. 12, for convenience of description, illustration is omitted for a component that is less related to this example embodiment out of the components illustrated in FIG. 4 and FIG. 8.

As illustrated in FIG. 12, in the biometric imaging system 10 according to the eighth example embodiment, a member above the arrangement position where the finger 50 is to be placed, is configured as a magic mirror 210. The magic mirror 210 is configured to transmit light from a lower side thereof, but not to transmit light from an upper side thereof. Therefore, it is possible to visually recognize a state of the lower side (e.g., the position of the finger 50) from the upper side of the magic mirror 210. On the other hand, the light from the upper side of the magic mirror 210 does not reach the lower side (i.e., the camera 18 side).

### (Technical Effect)

Next, a technical effect obtained by the biometric imaging system 10 according to the eighth example embodiment will be described.

As described in FIG. 12, in the biometric imaging system 10 according to the eighth example embodiment, the user may visually recognize the position of the living body even if there is a member on a side upper than the arrangement position where the living body is placed (i.e., on a side closer to the eyes of the user). Therefore, it is easier to place the living body than when the position of the living body is hardly visually recognized. Since the light from the upper side is not transmitted, external light or the like does not affect the imaging by the camera 18.

### Ninth Example Embodiment

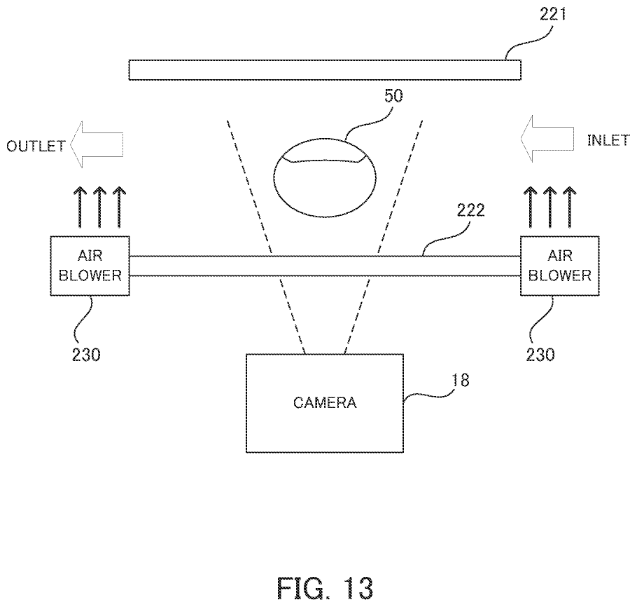

The biometric imaging system 10 according to a ninth example embodiment will be described with reference to FIG. 13. The ninth example embodiment is partially different from the first to eighth example embodiments only in the configuration and operation, and may be the same as each of the example embodiments described above only in the other parts. For this reason, a part that is different from each of the example embodiments described above will be described in detail below; and a description of other overlapping parts will be omitted as appropriate.

### (Configuration and Operation)

First, with reference to FIG. 13, a configuration and operation of the biometric imaging system 10 according to the ninth example embodiment will be described. FIG. 13 is a side view illustrating the configuration and operation of the biometric imaging system according to the ninth example embodiment. In FIG. 13, the same components as those illustrated in FIG. 4 and FIG. 8 carry the same reference numerals. Furthermore, in FIG. 13, for convenience of description, illustration is omitted for a component that is less related to this example embodiment out of the components illustrated in FIG. 4 and FIG. 8.

As illustrated in FIG. 13, the biometric imaging system 10 according to the ninth example embodiment includes an upper surface member 221 and a lower surface member 222. The image of the fingerprint is captured by guiding the finger 50 between the upper surface member 221 and the lower surface member 222. For example, the user puts the finger 50 from an inlet on a right side of the drawing, slides the finger 50 laterally as it is, and stops the finger 50 in the imaging range of the camera 18. Then, when the imaging is ended, the user slides the finger 50 again to put the finger 50 out of an outlet on a left side of the drawing.

Here, especially in this example embodiment, the air blower 230 is provided on the inlet and the outlet. The air blower 230 is configured to perform air blowing toward the finger 50. Specifically, the air blower 230 on the inlet side performs the air blowing toward the finger 50 when the finger 50 passes through the inlet. Furthermore, the air blower 230 on the outlet side performs the air blowing toward the finger 50 when the finger 50 passes through the outlet. The air blower 230 may always perform the air blowing, or may perform the air blowing when detecting the presence of the finger 50.

### (Technical Effect)

Next, a technical effect obtained by the biometric imaging system 10 according to the ninth example embodiment will be described.

As described in FIG. 13, in the biometric imaging system 10 according to the ninth example embodiment, the air blowing is performed on the living body by the blower 230. In this way, it is possible to blow off dirt or wet from the finger before and after the image is captured.

### Tenth Example Embodiment

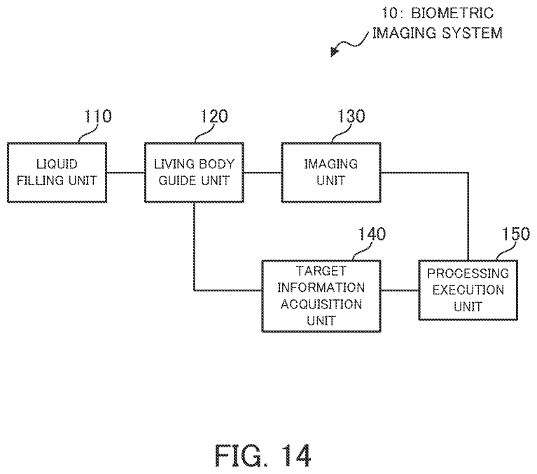

The biometric imaging system 10 according to a tenth example embodiment will be described with reference to FIG. 14. The tenth example embodiment is partially different from the first to ninth example embodiments only in the configuration and operation, and may be the same as each of the example embodiments described above in the other parts. For this reason, a part that is different from each of the example embodiments described above will be described in detail below, and a description of other overlapping parts will be omitted as appropriate.

### (Functional Configuration)

First, with reference to FIG. 14, a functional configuration of the biometric imaging system 10 according to the tenth example embodiment will be described. FIG. 14 is a block illustrating the functional configuration of the biometric imaging system according to the tenth example embodiment. In FIG. 14, the same components as those illustrated in FIG. 2 carry the same reference numerals.

As illustrated in FIG. 14, the biometric imaging system 10 according to the tenth example embodiment includes, as components for realizing the functions thereof, the liquid filling unit 110, the living body guide unit 120, the imaging unit 130, a target information acquisition unit 140, and a processing execution unit 150. That is, the biometric imaging system 10 according to the tenth example embodiment further includes the target information acquisition unit 140 and the processing execution unit 150, in addition to the configuration in the first example embodiment (see FIG. 2). The target information acquisition unit 140 and the processing execution unit 150 may be processing blocks realized or implemented by the processor 11 (see FIG. 1).

The target information acquisition unit 140 is configured to acquire information about the user (hereinafter referred to as “target information” as appropriate), from the user who captures the image of the living body. The target information acquisition unit 140 is configured to be acquire the target information from a portable terminal such as a smartphone, a wearable terminal, a card, or the like. The target information acquisition unit 140 may acquire the target information at the timing when the image of the living body is captured. Alternatively, the target information acquisition unit 140 may acquire the target information at the timing before or after the image of the living body is captured. The target information may be information for identifying the user, for example. The target information acquired by the target information acquisition unit 140 is configured to be outputted to the processing execution unit 150.

The processing execution unit 150 is configured to perform various processes on the basis of the image of the living body captured by the imaging unit 130. The processing execution unit 150 may be configured to perform an authentication process using the image of the living body, for example. In addition to the authentication process, the processing execution unit 150 may be configured to perform a payment process based on a payment method associated with the authorized user. In particular, the processing execution unit 150 according to this example embodiment utilizes the target information acquired by the target information acquisition unit 140, in addition to the image of the living body captured by the imaging unit 130. For example, when the processing execution unit 150 performs the authentication process, the authentication process may be two-factor authentication including authentication using the image of the living body and the authentication using the target information.

### (Technical Effect)

Next, a technical effect obtained by the biometric imaging system 10 according to the tenth example embodiment will be described.

As described in FIG. 14, in the biometric imaging system 10 according to the tenth example embodiment, the process performed by the processing execution unit 150 uses the target information acquired by the target information acquisition unit 140. In this way, it is possible to perform the process to be performed by the processing execution unit 150, more properly than when the target information is not used. For example, it is possible to improve accuracy when the identity of the user is determined, so that the security of the process can be enhanced.

### The Eleventh Example Embodiment

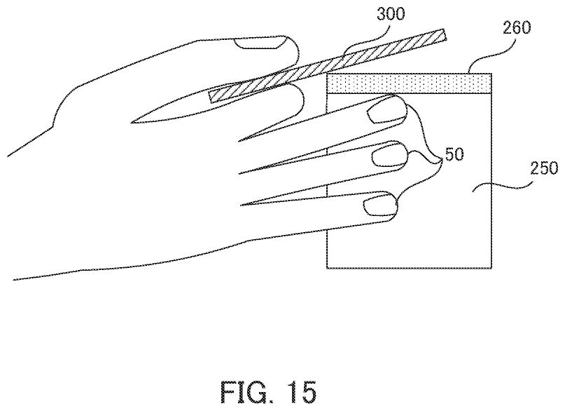

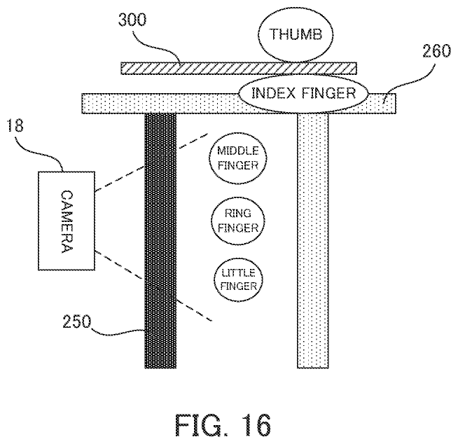

The biometric imaging system 10 according to an eleventh example embodiment will be described with reference to FIG. 15 and FIG. 16. The eleventh example embodiment describes a specific configuration example of the tenth example embodiment, and may be the same as each of the example embodiments described above in the other parts. For this reason, a part that is different from each of the example embodiments described above will be described in detail below, and a description of other overlapping parts will be omitted as appropriate.

### (Configuration and Operation)

First, with reference to FIG. 15 and FIG. 16, a configuration and operation of the biometric imaging system 10 according to the eleventh example embodiment will be described. FIG. 15 is a side view illustrating the configuration and operation of the biometric imaging system according to the eleventh example embodiment. FIG. 16 is a cross sectional view illustrating the configuration and operation of the biometric imaging system according to the eleventh example embodiment. In FIG. 15 and FIG. 16, the same components as those illustrated in FIG. 4 and FIG. 8 carry the same reference numerals. Furthermore, in FIG. 15 and FIG. 16, for convenience of description, illustration is omitted for a component that is less related to this example embodiment out of the components illustrated in FIG. 4 and FIG. 8.

As illustrated in FIG. 15 and FIG. 16, the biometric imaging system 10 according to the eleventh example embodiment includes a fingerprint scanning surface 250 that scans the finger 50 of the user to capture the image of the fingerprint, and a card scanning surface 260 that acquires the target information from a card 300 held by the user. For example, the user may hold the card 300 with the thumb and index finger over the card scan surface 260, while holding the middle finger, ring finger, and little finger over the fingerprint scanning surface 250.

### (Technical Effect)

Next, a technical effect obtained by the biometric imaging system 10 according to the eleventh example embodiment will be described.

As described in FIG. 15 and FIG. 16, according to biometric imaging system 10 in the eleventh example embodiment, it is possible to acquire the target information simultaneously with the capture of the image of the living body.

### Twelfth Example Embodiment

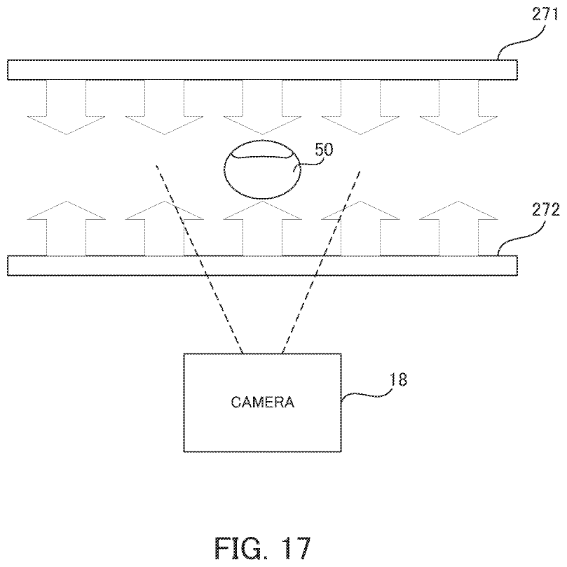

The biometric imaging system 10 according to a twelfth example embodiment will be described with reference to FIG. 17. The twelfth example embodiment is partially different from the first to eleventh example embodiments only in the configuration and operation, and may be the same as each of the example embodiments described above in the other parts. For this reason, a part that is different from each of the example embodiments described above will be described in detail below; and a description of other overlapping parts will be omitted as appropriate.

### (Configuration and Operation)

First, with reference to FIG. 17, a configuration and operation of the biometric imaging system 10 according to the twelfth example embodiment will be described. FIG. 17 is a side view illustrating the configuration and operation of the biometric imaging system according to the twelfth example embodiment. In FIG. 17, the same components as those illustrated in FIG. 4 and FIG. 8 carry the same reference numerals. Furthermore, in FIG. 17, for convenience of description, illustration is omitted for a component that is less related to this example embodiment out of the components illustrated in FIG. 4 and FIG. 8.

As illustrated in FIG. 17, the biometric imaging system 10 according to the twelfth example embodiment includes an upper surface member 271 and a lower surface member 272, as in the ninth example embodiment. The image of the fingerprint is captured by guiding the finger 50 between the upper surface member 271 and the lower surface member 272.
Here, especially in this example embodiment, air is blown toward a lower side from the upper surface member 271. On the other hand, air is blown toward an upper side from the lower surface member 272. At this time, a flow of air from the upper surface member 271 and a flow of air from the lower surface member 272, are considered to have the same degree of force. Therefore, when the finger 50 is placed between the upper surface member 271 and the lower surface member 272, due to the force of the air, the finger 50 is placed just near a middle of the upper surface member 271 and the lower surface member 272 (i.e., a level at which the flows of air collide). In this example embodiment, the arrangement position where the finger 50 is placed in this way, is a position suitable for imaging of the camera 18.

The air blowing may be always performed from the upper surface member 271 and the lower surface member 272, or the air blowing may be performed only when the finger 50 is detected. Furthermore, the flow of air from the upper surface member 271 and the flow of air from the lower surface member 272 may not always have the same degree of force, and the air blowing may be performed in different forces depending on the situation. For example, when it is desired to place the finger 50 at a slightly higher position, the air blowing from the upper side may be weaken, and the air blowing from the lower side may be increased. Similarly, when it is desired to place the finger 50 at a slightly lower position, the air blowing from the upper side may be increased, and the air blowing from the lower side may be weakened.

### (Technical Effect)

Next, a technical effect obtained by the biometric imaging system 10 according to the twelfth example embodiment will be described.

As described in FIG. 17, in the biometric imaging system 10 according to the twelfth example embodiment, in addition to the guiding by the liquid for filling, the guiding by the flow of air is performed. Therefore, it is possible to guide the living body to the arrangement position, more properly than when only the liquid for filling is used for the guiding. In addition, blowing the flow of air also makes it possible to blow off the dirt and wet of the living body.

A processing method in which a program for allowing the configuration in each of the example embodiments to operate so as to realize the functions in each example embodiment is recorded on a recording medium, and in which the program recorded on the recording medium is read as a code and is executed on a computer, is also included in the scope of each of the example embodiments. That is, a computer-readable recording medium is also included in the range of each of the example embodiments. Not only the recording medium on which the above-described program is recorded, but also the program itself is also included in each example embodiment.

The recording medium to use may be, for example, a floppy disk (registered trademark), a hard disk, an optical disk, a magneto-optical disk, a CD-ROM, a magnetic tape, a nonvolatile memory card, or a ROM. Furthermore, not only the program that is recorded on the recording medium and executes processing alone, but also the program that operates on an OS and executes processing in cooperation with the functions of expansion boards and another software, is also included in the scope of each of the example embodiments. In addition, the program itself may be stored in a server, and a part or all of the program may be downloaded from the server to a user terminal.

### Supplementary Notes

The example embodiments described above may be further described as, but not limited to, the following Supplementary Notes.

### (Supplementary Note 1)

A biometric imaging system according to Supplementary Note 1 is a biometric imaging system including: an imaging unit that images a living body present in an imaging range: a filling unit that fills the imaging range with liquid: and a guide unit that guides the living body to an arrangement position where the living body is to be placed, by using the liquid.

### (Supplementary Note 2)

A biometric imaging system according to Supplementary Note 2 is the biometric imaging system according to Supplementary Note 1, wherein the filling unit includes a container for storing the liquid, and the guide unit guides the living body to the arrangement position by using an amount of the liquid stored in the container.

### (Supplementary Note 3)

A biometric imaging system according to Supplementary Note 3 is the biometric imaging system according to Supplementary Note 2, further including a discharge control unit that discharges the liquid in the container, after guiding by the guide unit is ended.

### (Supplementary Note 4)

A biometric imaging system according to Supplementary Note 4 is the biometric imaging system according to Supplementary Note 1, wherein the filling unit fills the imaging range with the liquid of a mist form, and the guide unit applies guide light to the liquid of the mist form, thereby to guide the living body to the arrangement position.

### (Supplementary Note 5)

A biometric imaging system according to Supplementary Note 5 is the biometric imaging system according to Supplementary Note 4, wherein the guide unit applies first guide light that is visible light of a first wavelength and second guide light that is visible light of a second wavelength that is different from the first wavelength, so as to cross at the arrangement position where the living body is to be placed.

### (Supplementary Note 6)

A biometric imaging system according to Supplementary Note 6 is the biometric imaging system according to Supplementary Note 4 or 5, further including an air blowing unit that is disposed between the imaging unit and an area filled with the liquid of the mist form, and that performs air blowing such that the liquid of the mist form does not adhere to the imaging unit.

### (Supplementary Note 7)

A biometric imaging system according to Supplementary Note 7 is the biometric imaging system according to any one of Supplementary Notes 4 to 6, further including a drying unit that blows warm air for drying the liquid of the mist form, after guiding by the guide unit is ended.

### (Supplementary Note 8)

A biometric imaging apparatus according to Supplementary Note 8 is a biometric imaging apparatus including: an imaging unit that images a living body present in an imaging range: a filling unit that fills the imaging range with liquid: and a guide unit that guides the living body to an arrangement position where the living body is to be placed, by using the liquid.

### (Supplementary Note 9)

A biometric imaging method according to Supplementary Note 9 is a biometric imaging method executed by at least one computer, the biometric imaging method including: filling an imaging range of an imaging unit with liquid: guiding a living body to an arrangement position where the living body is to be placed, by using the liquid: and imaging the guided living body.

### (Supplementary Note 10)

A recording medium according to Supplementary Note 10 is a recording medium on which a computer program that allows at least one computer to execute the biometric imaging method is recorded, the biometric imaging method including: filling an imaging range of an imaging unit with liquid: guiding a living body to an arrangement position where the living body is to be placed, by using the liquid: and imaging the guided living body.

### (Supplementary Note 11)

A computer program according to Supplementary Note 11 is a computer program that allows at least one computer to execute the biometric imaging method, the biometric imaging method including: filling an imaging range of an imaging unit with liquid: guiding a living body to an arrangement position where the living body is to be placed, by using the liquid: and imaging the guided living body.

This disclosure is not limited to the examples described above and is allowed to be changed, if desired, without departing from the essence or spirit of this disclosure which can be read from the claims and the entire identification. A biometric imaging system, a biometric imaging apparatus, a biometric imaging method, and a recording medium with such changes are also intended to be within the technical scope of this disclosure.

### DESCRIPTION OF REFERENCE CODES

10 Biometric imaging system
11 Processor
18 Camera
19 Drive apparatus
20 Container
25 Discharge drive unit
30 Liquid
40 Mist
50 Finger
60 Light source
61 First light source
62 Second light source
70 Guide light
71 First guide light
72 Second guide light
75 Intersection
80 Blower cylinder
90 Dry air blower
110 Liquid filling unit
120 Living body guide unit
130 Imaging unit
140 Target information acquisition unit
150 Processing execution unit
210 Magic mirror
221 Upper surface member
222 Lower surface member
230 Air blower
250 Fingerprint scanning surface
260 Card scan surface
271 Upper surface member
272 Lower surface member
300 Card

What is claimed is:

1. A biometric imaging system comprising:
at least one memory that is configured to store instructions; and
at least one processor that is configured to execute the instructions to image a living body present in an imaging range;
fill the imaging range with liquid; and
guide the living body to an arrangement position where the living body is to be placed, by using the liquid.

2. The biometric imaging system according to claim 1, wherein
the biometric imaging system includes a container for storing the liquid, and
the at least one processor is configured to execute the instructions to guide the living body to the arrangement position by using an amount of the liquid stored in the container.

3. The biometric imaging system according to claim 2, wherein the at least one processor is configured to execute the instructions to discharge the liquid in the container, after guiding is ended.

4. The biometric imaging system according to claim 1, wherein the at least one processor is configured to execute the instructions to
fill the imaging range with the liquid of a mist form, and
apply guide light to the liquid of the mist form, thereby to guide the living body to the arrangement position.

5. The biometric imaging system according to claim 4, wherein the at least one processor is configured to execute the instructions to apply first guide light that is visible light of a first wavelength and second guide light that is visible light of a second wavelength that is different from the first wavelength, so as to cross at the arrangement position where the living body is to be placed.

6. The biometric imaging system according to claim 4, further comprising an air blowing unit that is disposed between the imaging unit and an area filled with the liquid of the mist form, and that performs air blowing such that the liquid of the mist form does not adhere to the imaging unit.

7. The biometric imaging system according to claim 4, further comprising a drying unit that blows warm air for drying the liquid of the mist form, after guiding by the guide unit is ended.

8. (canceled)

9. A biometric imaging method executed by at least one computer, the biometric imaging method including:
filling an imaging range of an imaging unit with liquid;
guiding a living body to an arrangement position where the living body is to be placed, by using the liquid; and
imaging the guided living body.

10. A non-transitory recording medium on which a computer program that allows at least one computer to execute the biometric imaging method is recorded, the biometric imaging method including:
filling an imaging range of an imaging unit with liquid;
guiding a living body to an arrangement position where the living body is to be placed, by using the liquid; and
imaging the guided living body.
